(19) United States
(12) Patent Application Publication
(10) Pub. No.: US 2018/0183090 A1
(43) Pub. Date: Jun. 28, 2018

(54) SOLID ELECTROLYTE AND LITHIUM BATTERY EMPLOYING THE SAME

(71) Applicant: INDUSTRIAL TECHNOLOGY RESEARCH INSTITUTE, Hsinchu (TW)

(72) Inventors: Ting-Ju YEH, Taipei City (TW); Ya-Chi CHANG, Zhunan Township (TW); Shu-Chun YU, Taipei City (TW); Shih-Chieh LIAO, Taoyuan City (TW)

(73) Assignee: INDUSTRIAL TECHNOLOGY RESEARCH INSTITUTE, Hsinchu (TW)

(21) Appl. No.: 15/392,343

(22) Filed: Dec. 28, 2016

(30) Foreign Application Priority Data
Dec. 27, 2016 (TW) 105143317

(51) Int. Cl. H01M 10/056; H01M 4/38; H01M 4/505; H01M 4/525; C08G 65/22

(52) U.S. Cl. CPC H01M 10/056; H01M 4/382; H01M 2300/0091; H01M 4/525; C08G 65/22; H01M 4/505

(57) ABSTRACT

A solid electrolyte is provided. The solid electrolyte includes inorganic ceramic electrolytes and an organic polymer. The organic polymer physically combines to the inorganic ceramic electrolytes. The organic polymer includes a repeat unit of formula (I),

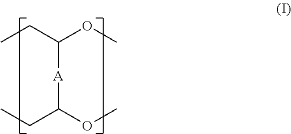

wherein the A includes the following formula (II):

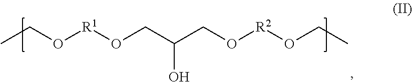

wherein each of R¹ and R² is independently selected at least one from the group consisting of the following groups: C₂-C₄ aliphatic alkyl, optionally substituted phenyl, bisphenol, bisphenol A, bisphenol F, and bisphenol S. The organic polymer is distributed uniformly between the inorganic ceramic electrolytes. The solid electrolyte has a conducting ion path. The solid electrolyte has a conducting ion path.

### CROSS REFERENCE TO RELATED APPLICATIONS

The application is based on, and claims priority from, Taiwan Application Serial Number 105143317, filed on Dec. 27, 2016, the disclosure of which is hereby incorporated by reference herein in its entirety.

### TECHNICAL FIELD

The present disclosure relates to a solid electrolyte and a lithium battery employing the same.

### BACKGROUND

Although the inorganic ceramic electrolyte used in the solid lithium battery has high conductivity, the impedance of the interface between the positive electrode and the negative electrode is high. In addition, the traditional inorganic ceramic electrolyte is very brittle and has poor film-forming ability and poor mechanical properties and cannot be continuously produced.

To improve the above shortcomings, various solid electrolytes have been currently developed. However, although the mechanical properties can be improved by purely introducing organic polymers into inorganic ceramic electrolytes, the impedance will be increased and the conductivity will be decreased because of the poor ionic conductivity of the polymer itself. Therefore, most of the current solid electrolytes are quasi-solid electrolytes. That is, other than inorganic ceramic electrolytes, organic polymers and liquid electrolytes are added to solve the problem of the interface impedance faced by the traditional inorganic ceramic electrolytes.

However, the existence of liquid electrolytes may produce problems such as liquid leakage, being flammable, poor cycle life, gassing, not being high-temperature resistant. Therefore, a solid electrolyte, which still has an excellent ionic conductivity when no liquid electrolyte is added, is currently needed.

### SUMMARY

According to an embodiment, the present disclosure provides a solid electrolyte, including: an inorganic ceramic electrolyte and an organic polymer. The organic polymer physically combines with the inorganic ceramic electrolyte, wherein the organic polymer includes a repeat unit of formula (I),

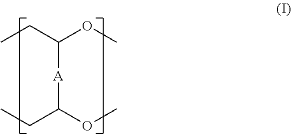

wherein A includes the following general formula (II):

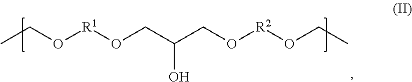

wherein each of R¹ and R² is independently selected at least one from the group consisting of the following groups: C₂˜C₄ aliphatic alkyl, optionally substituted phenyl, bisphenol, bisphenol A, bisphenol F, and bisphenol S;
wherein the organic polymer is distributed uniformly between the inorganic ceramic electrolytes, and the solid electrolyte has an ion-conducting path.

According to another embodiment, the present disclosure provides a lithium battery, including: a positive electrode; a negative electrode; and an ion-conducting layer disposed between the positive electrode and the negative electrode. The ion-conducting layer includes the aforementioned solid electrolyte.

A detailed description is given in the following embodiments with reference to the accompanying drawings.

### BRIEF DESCRIPTION OF DRAWINGS

The present disclosure can be more fully understood by reading the subsequent detailed description and examples with references made to the accompanying drawings, wherein:

FIGS. 1A, 1B illustrate the Fourier transform infrared (FT-IR) spectroscopic images of the epoxy resins before and after crosslinking according to some embodiments.

FIG. 2 illustrates the result of a current discharge test for the lithium battery with the solid electrolyte provided by the present disclosure according to an embodiment.

### DETAILED DESCRIPTION

The embodiments of the present disclosure provide a solid electrolyte. By using initiators, epoxy groups-containing organic oligomers are ring-opening polymerized, and through the three-dimensional network polymerization occurred in the organic oligomers, organic polymers and inorganic ceramic electrolytes are tightly connected together, forming an organic-inorganic composite solid electrolyte. The organic polymer in the organic-inorganic composite solid electrolyte provided by the present disclosure has a three-dimensional network structure and high ionic conductivity, and it can be used as an adhesive and also has a conductive function for lithium ions. Therefore, after introducing this kind of organic polymer, the solid electrolyte possesses high ionic conductivity, less brittleness, improved film-forming ability and mechanical properties. Furthermore, the resulting solid electrolyte is capable of being produced continuously, and thus reducing the process cost.

In an embodiment of the present disclosure, a solid electrolyte is provided. The solid electrolyte includes an inorganic ceramic electrolyte and an organic polymer. The organic polymer is physically combined with the inorganic ceramic electrolyte. In an embodiment of the present disclosure, the weight percentage of the inorganic ceramic electrolyte is 50˜95 wt %, for example, 80˜90 wt %, based on the weight of the solid electrolyte. The organic polymer is distributed uniformly between the inorganic ceramic electrolytes, and the solid electrolyte has an ion-conducting path. Specifically, the aforementioned ion-conducting path is an ion-conducting path continuously distributed in the solid electrolyte.

In an embodiment of the present disclosure, the inorganic ceramic electrolyte may include a sulfide electrolyte, an oxide electrolyte, or a combination thereof. The aforementioned sulfide electrolyte may include Li₁₀GeP₂S₁₂ (LGPS), Li₁₀SnP₂S₁₂, 70Li₂S.30P₂S₅, or 50Li₂S-17P₂S₅-33LiBH₄. The aforementioned oxide electrolyte may include Li₇La₃Zr₂O₁₂ (LLZO), Li_{6.75}La₃Zr_{1.75}Ta_{0.25}O₁₂ (LLZTO), Li_{0.33}La_{0.56}TiO₃ (LLTO), Li_{1.3}Al_{0.3}Ti_{1.7}(PO₄)₃ (LATP), or Li_{1.6}Al_{0.6}Ge_{1.4}(PO₄)₃ (LAGP).

In an embodiment of the present disclosure, the organic polymer may include a repeat unit of formula (I):

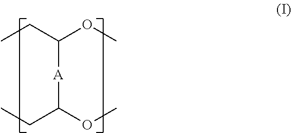

wherein A includes the following general formula (II):

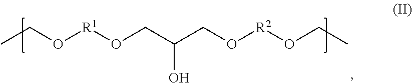

wherein each of R¹ and R² is independently selected at least one from the group consisting of the following groups: C₂˜C₄ aliphatic alkyl, optionally substituted phenyl, bisphenol, bisphenol A, bisphenol F, and bisphenol S.

In this embodiment, two ends of the organic oligomer forming this organic polymer both have epoxy groups. Ring-opening polymerization may be conducted by using initiators, and therefore forming organic polymers with a three-dimensional network structure. It should be noted that the aforementioned repeat unit of formula (I) may be orderly-arranged or disorderly-arranged in the organic polymer, and therefore it is not limited to network molecules which are orderly-arranged.

In addition, the dielectric constant D of the organic oligomer may be 10 or above 10. The higher the dielectric constant is, the better ability of absorbing lithium ions and transmitting lithium ions is. It should be noted that since the organic polymer has soft segments as shown in formula (II), for example, ether and alkyl, lithium ions are transmitted by a way of hopping in the high polarity molecule. Although the conductivity is not as good as that of inorganic ceramic materials, it is able to effectively decrease the interface impedance. Also, since the organic polymer itself is an elastomer, after being mixed with the inorganic ceramic electrolyte, the brittleness of the inorganic ceramic electrolyte may also be decreased, increasing the degree of closeness of the final solid electrolyte.

In an embodiment of the present disclosure, the manufacture of the solid electrolyte begins with evenly mixing the abovementioned inorganic ceramic electrolyte and the organic oligomer with epoxy groups at both of the two ends. Then, the initiator is added to make the epoxy groups at the ends of the organic polymer ring-opening to conducting a crosslinking network polymerization to form the organic polymer. The aforementioned organic oligomer may be, for example, alkyl ether resin such as 1,4-butanediol diglycidyl ether, bisphenol A epoxy resin, or bisphenol S epoxy resin. By the three-dimensional network polymerization conducted in the organic oligomer by using the initiator, it is able for the organic polymer to be tightly connected with the inorganic ceramic electrolyte in a physical winding way without adding additional adhesives, forming a continuously distributed ion-conducting path in the solid electrolyte. In embodiments of the present disclosure, the aforementioned organic oligomer may include more than one kind of organic oligomers.

Therefore, one end of the aforementioned organic polymer may further include a nucleophilic group, such as CH₃COO⁻, OH⁻, BF₄⁻, PF₆⁻, ClO₄⁻, TFSI⁻, AsF₆⁻, or SbF₆⁻, which is dissociated from an initiator. In an embodiment of the present disclosure, the initiator may include an ionic compound capable of dissociating to produce nucleophilic groups. The aforementioned ionic compound may include lithium salts, lithium acetate (LiCH₂COO), lithium hydroxide (LiOH), or other ionic compounds capable of dissociating to produce nucleophilic groups. The aforementioned lithium salts may include LiBF₄, LiPF₆, LiClO₄, LiTFSI, LiAsF₆, or LiSbF₆.

In an embodiment of the present disclosure, the molar ratio of the initiator and the organic oligomer may be 1:4˜1:26, for example, 1:4, 1:8, 1:13, or 1:26. As mentioned above, the addition of initiators is able to produce a ring-opening polymerization of the epoxy groups in the organic oligomers, forming a three-dimensional network structure. However, if the ratio of the initiator is too high, the ratio of the network structure in the organic polymer will be too high, and therefore it is not easy for the molecules to swing and transmit lithium ions, and becoming difficult to transmit ions. If the ratio of the initiator is too low, the ratio of the network structure in the organic polymer is too low, affecting the mechanical properties and adhesion of the organic polymer.

It is worth mentioning that, in the present disclosure, as long as the ionic compound is capable of dissociating to produce nucleophilic groups, it can be used as the initiator used in the present disclosure to produce a ring-opening polymerization of the epoxy groups in the organic oligomer; and also, it can act as an adhesive and has the function of conducting ions. However, when selecting an ionic compound with lithium ions as the initiator, except for producing a ring-opening polymerization of the epoxy groups in the organic oligomer, lithium sources may also be introduced to further increase the ionic conductivity.

In another embodiment of the present disclosure, the organic polymer may further include a repeat unit of formula (III):

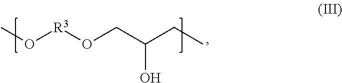

wherein R³ may be selected at least one from the group consisting of the following groups: C₂˜C₄ aliphatic alkyl, optionally substituted phenyl, bisphenol, bisphenol A, bisphenol F, and bisphenol S.

In this embodiment, the organic oligomer forming the organic polymer includes an epoxy resin with epoxy groups at both of the two ends. For example, alkyl ether resin such as 1,4-butanediol diglycidyl ether, bisphenol A epoxy resin, or bisphenol S epoxy resin. After producing a ring-opening polymerization by using initiators, the resulting organic polymer may have a structure which is partial linear and partial network. The initiators used in this embodiment may include other well-known initiators other than the initiators described in the present disclosure. The aforementioned repeat units of formula (I) and formula (III) may be orderly-arranged or disorderly-arranged in the organic polymer, and therefore it is not limited to linear molecules or network molecules which are orderly-arranged.

In an embodiment of the present disclosure, the manufacture of the solid electrolyte begins with evenly mixing the aforementioned inorganic ceramic electrolyte and the organic oligomer with epoxy groups at both of the two ends. Then, the initiator is added to make the epoxy groups at the ends of the organic polymer ring-opening to conducting a three-dimensional network crosslinking polymerization to form the organic polymer. Although the linear structure in the organic polymer may increase the softness of the chain to make it easy for transmitting lithium ions, it decreases the mechanical properties, causing the adhesion with the inorganic ceramic electrolyte becoming worse. On the contrary, the network structure in the organic polymer may improve the mechanical properties and increase the adhesion. The ratio of the initiator and the organic oligomer affects the degree of network crosslinking. More initiators make a higher degree of crosslinking. Therefore, the purpose to make the solid electrolyte have high ionic conductivity and high mechanical properties may be achieved by controlling the ratio of the initiator and the organic oligomer. In an embodiment of the present disclosure, the molar ratio of the organic molecule oligomer and the initiator may be 4:1˜26:1.

During the crosslinking polymerization reaction, the reaction time and the reaction temperature may be adjusted with different kinds of initiators. For example, while LiBF₄, LiPF₆ etc. are used as the initiator, the crosslinking reaction may be accomplished at about 90˜100° C. for about 5˜10 minutes. While LiClO₄, LiTFSI etc. are used as the initiator, the crosslinking reaction may be accomplished at about 170˜180° C. for about 120 minutes. However, the aforementioned parameter conditions of various crosslinking reactions may be adjusted according to practical needs, and are not limited hereto.

In another embodiment of the present disclosure, a lithium battery is also provided, including a positive electrode, a negative electrode, and an ion-conducting layer disposed between the positive electrode and the negative electrode. The ion-conducting layer includes the aforementioned solid electrolyte. In an embodiment of the present disclosure, the material of the positive electrode may include lithium nickel manganese cobalt oxide (LiNiₙMnₘCo₁₋ₙ₋ₘO₂, 0<n<1, 0<m<1, n+m<1), lithium manganate (LiMn₂O₄), lithium iron phosphate (LiFePO₄), lithium manganese dioxide (LiMn₂O₄), lithium cobalt oxide (LiCoO₂), lithium nickel cobalt oxide (LiNiₚCo₁₋ₚO₂, 0<p<1), lithium nickel manganese oxide (LiNi_{q}Mn_{2-q}O₄, 0<q<2). In an embodiment of the present disclosure, the material of the negative electrode may include graphite, lithium titanium oxide (Li₄Ti₅O₁₂), or lithium.

Although the ionic conductivity of the inorganic ceramic electrolyte itself is superior than that of the organic polymer, there is an interface impedance problem. The purpose of the present disclosure is to use the fewest amount of organic polymers to capture the largest amount of inorganic ceramic electrolytes, wherein the organic polymer may play roles of adhesive and ionic conductor simultaneously, making the solid electrolyte have high ionic conductivity and improving the brittleness, film-forming ability, and mechanical properties thereof. In addition, the solid electrolyte provided by the present disclosure does not need additional liquid electrolyte, and it has low sensitivity to the environment, enhancing the simplicity of process. The solid electrolyte provided by the present disclosure has good conductivity (larger than 10⁻⁴ S/cm). Also, the lithium battery including this solid electrolyte can normally charge and discharge at a condition lower than 100° c.

The various Embodiments and Comparative Examples are listed below to illustrate the solid electrolyte, lithium battery provided by the present disclosure and the characteristics thereof.

### Effects of Different Initiators on the Conductivity of Crosslinked Epoxy Resins

The same amount of four kinds of lithium salts (LiBF₄, LiPF₆, LiClO₄, LiTFSI) used as initiators were separately added into epoxy resin of 1, 4-butanediol diglycidyl ether. The crosslinking polymerization reaction was performed according to the crosslinking conditions shown in Table 1. The molar ratio of the initiator and the organic oligomer was 1:13. The ionic conductivities of the four crosslinked epoxy resins formed by adding different initiators were measured. The results are as shown in Table 1.

TABLE 1

| Lithium | Reaction temperature | Reaction time | Ionic conductivity |
|---|---|---|---|
| salts | (° C.) | (min) | (S/cm) |
| LiBF₄ | 90 | 10 | 3.8 × 10⁻⁹ |
| LiPF₆ | 90 | 10 | 1.8 × 10⁻⁹ |
| LiClO₄ | 170 | 120 | 6.8 × 10⁻⁶ |
| LiTFSI | 170 | 120 | 6.4 × 10⁻⁶ |

According to Table 1, it was learned that, among the four lithium salts, the crosslinked epoxy resins formed by using LiClO₄ and LiTFSI as initiators have better ionic conductivities. Therefore, LiClO₄ which makes the crosslinked epoxy resin have high ionic conductivity was selected as the initiator to undergo the other analyses described below.

Analysis of Conductivity and FT-IR Spectroscopic Images of Crosslinked Epoxy Resins with Different Amounts of Initiators

LiClO₄ was used as the initiator and added into epoxy resin of 1, 4-butanediol diglycidyl ether according to the ratio shown in Table 2. The crosslinking polymerization reaction was performed at 140° C. for 10 hours. The ionic conductivities of the crosslinked epoxy resins formed by adding different amounts of LiClO₄ were measured. The results are shown in Table 2.

TABLE 2

Initiator:Epoxy resin

| molar ratio | weight ratio | Ionic conductivity (S/cm) |
|---|---|---|
| 1:26 | 2:98 | 4.8 × 10⁻⁷ |
| 1:13 | 4:96 | 8.2 × 10⁻⁷ |
| 1:8 | 6:94 | 6.8 × 10⁻⁶ |
| 1:4 | 10:90 | 2.8 × 10⁻⁶ |

It can be observed from Table 2 that as the amount of the initiator (LiClO₄) increases, the ionic conductivity of the resulting crosslinked epoxy resin also increases. However, when the molar ratio of the initiator (LiClO₄) and the epoxy resin (1, 4-butanediol diglycidyl ether) reached 1:4, the ionic conductivity decreases instead of increasing. The main reason is that too much initiator makes the organic polymer form a highly network crosslinked structure, and causing the conduction of ions becoming difficult.

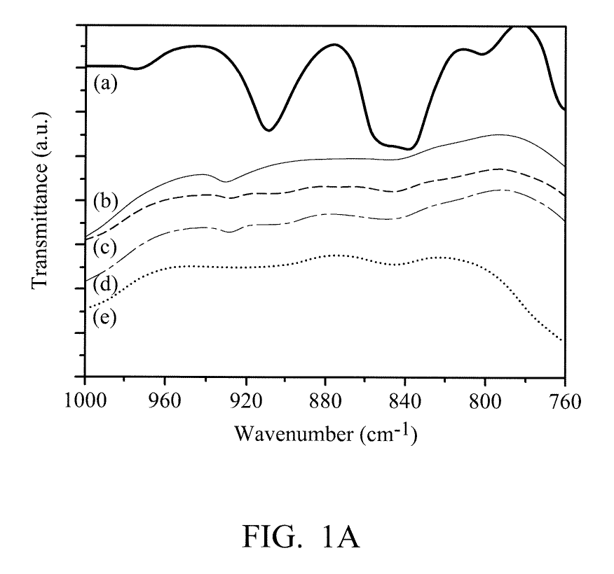

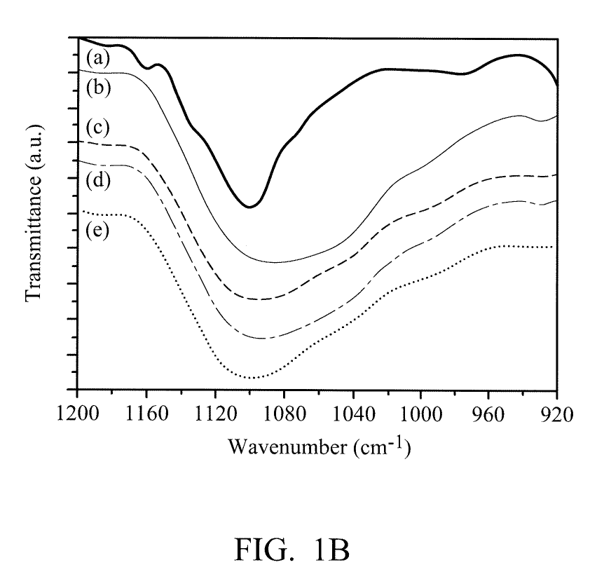

In addition, a comparative analysis of the Fourier Transform Infrared Spectroscopy (FT-IR) spectroscopic images of epoxy resins before and after the crosslinking was conducted. In FIG. 1A and FIG. 1B, FT-IR spectroscopic images were measured when (a) the epoxy resin was before crosslinking, (b) the molar ratio of the initiator (LiClO₄) and the epoxy resin was 1:26 (the weight ratio was 2:98), (c) the molar ratio of the initiator (LiClO₄) and the epoxy resin was 1:13 (the weight ratio was 4:96), (d) the molar ratio of the initiator (LiClO₄) and the epoxy resin was 1:8 (the weight ratio was 6:94), (e) the molar ratio of the initiator (LiClO₄) and the epoxy resin was 1:4 (the weight ratio was 10:90).

It can be observed from FIG. 1A that the absorption peaks of epoxy groups were at 910 cm⁻¹ and 840 cm⁻¹. However, after adding different amounts of the initiator (LiClO₄) according to the ratio shown in Table 2 and the crosslinking polymerization reaction was performed at 140° C. for 10 hours, the absorption peaks at 910 cm⁻¹ and 840 cm⁻¹ disappeared, representing that the epoxy groups were ring-opened because of the initiators and produced a crosslinking reaction.

It can be observed from FIG. 1B that the absorption peak of ether (C—O—C) was at 1094 cm⁻¹. After the ring-opening caused by the initiators produced a crosslinking reaction, a new absorption peak at 1066 cm⁻¹ appeared, which was the absorption peak of the ether group coupling lithium ions. It proved that lithium ions move on the molecular chain of epoxy resins and there was an interaction between them. This result corresponds to the result of the increased ionic conductivity of the solid electrolyte.

### Control Examples 1˜2

### The Differences of Conductivities Between the Commercial Adhesive CMC and Crosslinked Epoxy Resins

The crosslinked epoxy resins used in the present disclosure were formed according to the ratio shown in Table 3. Comparing the ionic conductivity of the crosslinked epoxy resins used in the present disclosure and the commercial adhesive of carboxymethyl cellulose (CMC), it was found that the ionic conductivity of the commercial CMC was 2.8×10⁻¹¹ (S/cm), which does not have a conductive function compared to the crosslinked epoxy resin (6.8×10⁻⁶ S/cm).

After analyzing the characteristics of the crosslinked epoxy resin and the commercial adhesive of carboxymethyl cellulose (CMC), the organic oligomers, initiators, and inorganic ceramic electrolytes were then mixed to form a solid electrolyte. The ionic conductivity and adhesion thereof and the charging and discharging characteristics of the lithium battery employing the same were measured.

### Comparative Example 1

The commercial adhesive CMC and the inorganic ceramic electrolyte LLZO were mixed according to the ratio shown in Table 3. The ionic conductivity of the resulting solid electrolyte was merely 1.7×10⁻¹⁰ (S/cm). The ratio of the commercial adhesive CMC and the inorganic ceramic electrolyte LLZO was based on a standard adhesive ability of being >0.1 Kgf.

### [Example 1]—Solid Electrolyte

6 g of 1, 4-butanediol diglycidyl ether and 23.64 g of the inorganic ceramic electrolyte LLZO were evenly mixed. 0.36 g of the initiator (LiClO₄) was added and heated to 170° C. to perform the crosslinking polymerization reaction for 2 hours to obtain the solid electrolyte.

### [Example 2]—Solid Electrolyte

4.5 g of 1, 4-butanediol diglycidyl ether and 25.32 g of the inorganic ceramic electrolyte LLZO were evenly mixed. 0.27 g of the initiator (LiClO₄) was added and heated to 170° C. to perform the crosslinking polymerization reaction for 2 hours to obtain the solid electrolyte.

### [Example 3]—Solid Electrolyte

3 g of 1, 4-butanediol diglycidyl ether and 26.82 g of the inorganic ceramic electrolyte LLZO were evenly mixed. 0.18 g of the initiator (LiClO₄) was added and heated to 170° C. to perform the crosslinking polymerization reaction for 2 hours to obtain the solid electrolyte.

### [Example 4]—Solid Electrolyte

2.1 g of 1, 4-butanediol diglycidyl ether and 27.774 g of the inorganic ceramic electrolyte LLZO were evenly mixed. 0.126 g of the initiator (LiClO₄) was added and heated to 170° C. to perform the crosslinking polymerization reaction for 2 hours to obtain the solid electrolyte.

TABLE 3

| | solid electrolyte | | | | | | |
|---|---|---|---|---|---|---|---|
| | inorganic ceramic | | organic polymer | | | | |
| | electrolyte | | organic oligomer | | initiator | ion | |
| | | content | | content | content | conductivity | adherence |
| | species | (wt %) | species | (wt %) | (wt %) | (S/cm) | (Kgf) |
| Control Example 1 | — | — | CMC | 100 | 0 | 2.8 × 10⁻¹¹ | — |
| Control Example 2 | — | — | epoxy resin^{note} | 94 | 6 | 6.8 × 10⁻⁶ | — |
| Comparative | LLZO | 93.64 | CMC | 6 | 0.36 | 1.7 × 10⁻⁷ | — |
| Example 1 | | | | | | | |
| Embodiment 1 | LLZO | 78.8 | epoxy resin | 20 | 1.2 | 1.9 × 10⁻⁶ | 0.277 |
| Embodiment 2 | LLZO | 84.1 | epoxy resin | 15 | 0.9 | 8.5 × 10⁻⁶ | 0.256 |
| Embodiment 3 | LLZO | 89.4 | epoxy resin | 10 | 0.6 | 1.2 × 10⁻⁴ | 0.18 |
| Embodiment 4 | LLZO | 92.58 | epoxy resin | 7 | 0.42 | 1.1 × 10⁻⁵ | 0 |

^{note}the epoxy resin is 1,4-butanediol diglycidyl ether

It can be observed from the aforementioned Comparative Examples and Examples that when the weight ratio of the inorganic ceramic electrolyte provided in the present disclosure was about 75˜95 wt % of the whole solid electrolyte, the solid electrolytes have excellent ionic conductivities of about 10˜700 times over the ionic conductivities of Comparative Examples. However, when the ratio of the inorganic ceramic electrolyte was too high (for example, higher than 92 wt %), the adhesion of the solid electrolyte became worse. The ionic conductivity of Example 1 was 1.9×10⁻⁶ S/cm, which was smaller than 6.8×10⁻⁶ S/cm of Comparative Example 2. It is mainly because the introduction of the inorganic ceramic electrolyte (LLZO) makes the free volume of epoxy resin decrease and make the chain wagging become difficult, thereby decreasing the ionic conductivity. However, after the inorganic ceramic electrolyte (LLZO) was introduced into the epoxy resin in Example 1, it can be used as a solid electrolyte and be applied to lithium batteries.

### [Example 5]—Lithium Battery

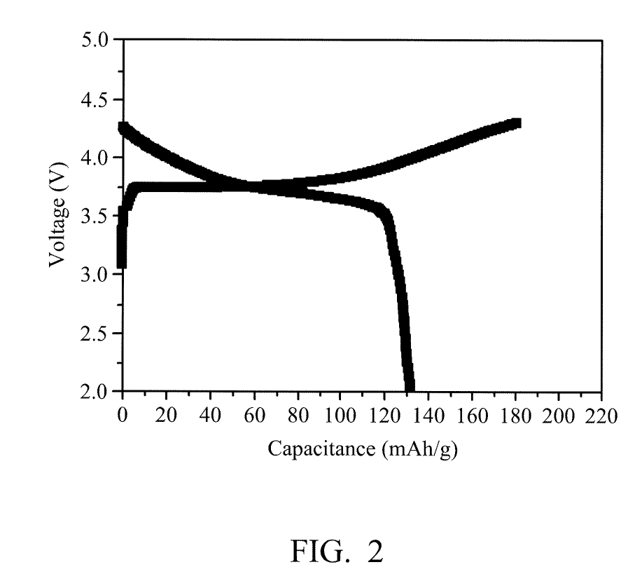

The solid electrolyte of Example 3 was put into the system of lithium battery. The material of the positive electrode used in the lithium battery was lithium nickel manganese cobalt oxide (LiNi_{0.5}Mn_{0.3}Co_{0.2}O₂), and the material of the negative electrode was lithium. As shown in FIG. 2, a charging and discharging test (4.3V−2.0V) was performed at 60° C. The measured charging capacity was 181 mAh/g, and the discharging capacity was 132 mAh/g.

The results of the aforementioned Examples can prove that, in the present disclosure, after evenly mixing inorganic ceramic electrolytes and organic oligomers with high ionic conductivity, by adding initiators to make organic oligomers to form organic polymers with a three-dimensional network structure, the organic polymers can tightly combine with the inorganic ceramic electrolytes without adding additional adhesive or liquid electrolyte. Also, an ion-conducting path is produced in the solid electrolyte. The purposes of improving the mechanical properties and increasing the ionic conductivity of the solid electrolytes are both achieved.

While the present disclosure has been described by several embodiments above, the present disclosure is not limited to the disclosed embodiments. Those skilled in the art may make various changes and modifications without departing from the spirit and scope of the present disclosure. Therefore, the protected scope of the present disclosure should be indicated by the following appended claims.

What is claimed is:

1. A solid electrolyte, comprising:
an inorganic ceramic electrolyte; and
an organic polymer physically combined with the inorganic ceramic electrolyte, wherein the organic polymer comprises a repeat unit of formula (I), 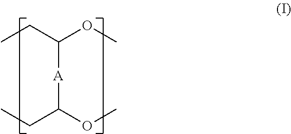
wherein A has the following general formula (II): 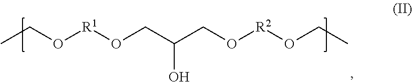
wherein each of R¹ and R² is independently selected at least one from the group consisting of the following groups: C₂˜C₄ aliphatic alkyl, optionally substituted phenyl, bisphenol, bisphenol A, bisphenol F, and bisphenol S;
wherein the organic polymer is distributed uniformly between the inorganic ceramic electrolytes, making the solid electrolyte have an ion-conducting path.

2. The solid electrolyte as claimed in claim 1, wherein the organic polymer further comprises a repeat unit of formula (III): 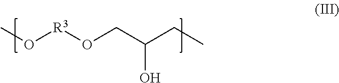
wherein R³ is selected at least one from the group consisting of the following groups: C₂˜C₄ aliphatic alkyl, optionally substituted phenyl, bisphenol, bisphenol A, bisphenol F, and bisphenol S.

3. The solid electrolyte as claimed in claim 2, wherein the repeat unit of formula (I) and the repeat unit of formula (III) are independently orderly-arranged or disorderly-arranged.

4. The solid electrolyte as claimed in claim 1, wherein the weight percentage of the inorganic ceramic electrolyte is 50˜95 wt %, based on the weight of the solid electrolyte.

5. The solid electrolyte as claimed in claim 1, wherein the inorganic ceramic electrolyte comprises a sulfide electrolyte, an oxide electrolyte, or a combination thereof.

6. The solid electrolyte as claimed in claim 5, wherein the sulfide electrolyte comprises Li₁₀GeP₂S₁₂ (LGPS), Li₁₀SnP₂S₁₂, 70Li₂S.30P₂S₅, or 50Li₂S-17P₂S₅-33LiBH₄.

7. The solid electrolyte as claimed in claim 6, wherein the oxide electrolyte comprises Li₇La₃Zr₂O₁₂ (LLZO), Li_{6.75}La₃Zr_{1.75}Ta_{0.25}O₁₂ (LLZTO), Li_{0.33}La_{0.56}TiO₃ (LLTO), Li_{1.3}Al_{0.3}Ti_{1.7}(PO₄)₃ (LATP), or Li_{1.6}Al_{0.6}Ge_{1.4}(PO₄)₃ (LAGP).

8. The solid electrolyte as claimed in claim 1, wherein an end of the organic polymer further comprises a nucleophilic group including CH₃COO⁻, OH⁻, BF₄⁻, PF₆⁻, ClO₄⁻, TFSI⁻, AsF₆⁻, or SbF₆⁻ dissociated from an initiator.

9. The solid electrolyte as claimed in claim 8, wherein the initiator comprises an ionic compound capable of dissociating to produce nucleophilic groups.

10. The solid electrolyte as claimed in claim 9, the ionic compound comprises lithium salts, lithium acetate (LiCH₂COO), or lithium hydroxide (LiOH).

11. The solid electrolyte as claimed in claim 10, wherein the lithium salts comprise LiBF₄, LiPF₆, LiClO₄, LiTFSI, LiAsF₆, or LiSbF₆.

12. A lithium battery, comprising:
a positive electrode;
a negative electrode; and
an ion-conducting layer disposed between the positive electrode and the negative electrode, wherein the ion-conducting layer includes the solid electrolyte as claimed in claim 1.

13. The lithium battery as claimed in claim 12, wherein the material of the positive electrode includes lithium nickel manganese cobalt oxide (LiNiₙMnₘCo₁₋ₙ₋ₘO₂, 0<n<1, 0<m<1, n+m<1), lithium manganate (LiMn₂O₄), lithium iron phosphate (LiFePO₄), lithium manganese dioxide (LiMn₂O₄), lithium cobalt oxide (LiCoO₂), lithium nickel cobalt oxide (LiNiₚCo₁₋ₚO₂, 0<p<1), lithium nickel manganese oxide (LiNi_{q}Mn_{2-q}O₄, 0<q<2).

14. The lithium battery as claimed in claim 12, wherein the material of the negative electrode comprises graphite, lithium titanium oxide (Li₄Ti₅O₁₂), or lithium.
